(19) United States
(12) Patent Application Publication
(10) Pub. No.: US 2023/0189251 A1
(43) Pub. Date: Jun. 15, 2023

(54) Capability Signaling in a Wireless Communication Network

(71) Applicant: Telefonaktiebolaget LM Ericsson (publ), Srovkholm (SE)

(72) Inventors: Ajit Nimbalker, Fremont, CA (US); Ravikiran Nory, San José, CA (US); Claes Tidestav, Bålsta (SE); Ilmiawan Shubhi, Malmö (SE)

(21) Appl. No.: 17/925,141

(22) PCT Filed: May 13, 2021
(86) PCT No.: PCT/EP2021/062788

§ 371 Date: Nov. 14, 2022

Related U.S. Application Data
(60) Provisional application No. 63/025,723, filed on May 15, 2020.

(51) Int. Cl. H04W 72/1263; H04W 72/23; H04W 72/54

(52) U.S. Cl. CPC H04W 72/1263; H04W 72/23; H04W 72/54

(57) ABSTRACT

A wireless device (12) transmits signaling (26) which indicates that the wireless device (12) supports cross-slot scheduling. Support for cross-slot scheduling indicates a range of values that the wireless device (12) supports for a triggering offset (20). A triggering offset (20) is an offset between: (i) a slot containing downlink control information (14) that triggers a set (16) of aperiodic channel state information reference signal, CSI-RS, resources; and (ii) a slot in which the set (16) of aperiodic CSI-RS resources is transmitted. The signaling (26) may enable a network node (15) that receives the signaling (26) to correspondingly transmit, to the wireless device (12), a control message which configures the wireless device (12) with a triggering offset (20) that has a value within the indicated range of values.

### TECHNICAL FIELD

The present application relates generally to a wireless communication network, and relates more particularly to capability signaling in such a network.

### BACKGROUND

Cross-slot scheduling is one of the mechanisms introduced in New Radio (NR) Rel-16 to allow user equipment (UE) power saving. The UE is configured with a minimum scheduling offset restriction that allows the UE opportunity to micro-sleep by ensuring a minimum gap between a control channel and the corresponding downlink signal/channel that a UE is expected to receive based on the Downlink Control Information (DCI) in the control channel, e.g., a Physical Downlink Control Channel (PDCCH). A similar gap may be ensured between a control channel and an uplink transmission for uplink. The same minimum gap that applies to Physical Downlink Shared Channel (PDSCH) scheduling is also applied for aperiodic Channel State Information Reference Signal (A-CSI RS) reception. Thus, the two parameters (KO or PDCCH-to-PDSCH scheduling offset) and A-CSI triggering offset have some inter-dependencies, when a UE is configured with a minimum scheduling offset restriction.

The value ranges for minimum KO value (0 to 16), A-CSI-RS triggering offset (e.g. {0, 1, 2, 3, 4, 16, 24} slots.), UE assistance related to minimum KO values, and possible set of KO values (0 to 32) may have different values and ranges, which can lead to undesirable scheduling restrictions or delays in cases with mismatch. For example, if a minimum KO value of 5 is enforced, the network may be forced to use a large A-CSI-RS triggering offset (e.g. 16 slots). Therefore, the value range of A-CSI-RS triggering offset was extended for cross-slot scheduling. For other reasons, the value range of A-CSI-RS triggering offset was extended for cross-carrier A-CSI triggering with different numerologies between PDCCH and CSI-RS. There currently exist certain challenge(s). Existing signaling proves insufficient for the network to unambiguously know a UE's capability to support the extended value range of A-CSI-RS triggering offset, at least under some conditions for the cross-slot scheduling case. The conditions may include for instance a condition under which the extended range can be configured for a UE indicating support of such capability.

### SUMMARY

Certain aspects of the present disclosure and their embodiments may provide solutions to these or other challenges. Some embodiments use UE capability signaling to explicitly indicate to the network whether and under what conditions the extended offset value range for A-CSI-RS triggering offset is supported, e.g., for cross-slot scheduling based UE power savings and/or for cross-carrier A-CSI-RS triggering with different numerologies.

In some embodiments, a UE indicating support for “Cross Slot Scheduling” also indicates the capability (e.g. implicitly or explicitly) to support the new Radio Resource Control (RRC) parameter (e.g. aperiodicTriggeringOffsetExt-r16.) and/or the extended offset value range for A-CSI-RS triggering offset. For example, in the implicit case, support of extended offset value range for A-CSI triggering offset via aperiodicTriggeringOffsetExt-r16 can become a component within the capability to “Cross Slot Scheduling”.

In other embodiments, a UE indicates a separate capability to support the new RRC parameter (e.g. aperiodicTriggeringOffsetExt-r16.) and/or the extended offset value range for A-CSI triggering offset. For example, the capability can be separate from the capability indicating support for “Cross slot scheduling”.

Certain embodiments may provide one or more of the following technical advantage(s).

Some embodiments make the UE capability unambiguous with respect to the support of extended offset value range for A-CSI-RS triggering offset, e.g., for the case with cross-slot scheduling based power savings.

Generally, then, some embodiments herein include a method performed by a wireless device. The method comprises transmitting signaling which indicates that the wireless device supports cross-slot scheduling. Support for cross-slot scheduling indicates a range of values that the wireless device supports for a triggering offset. Here, a triggering offset is an offset between a slot containing downlink control information that triggers a set of aperiodic channel state information reference signal, CSI-RS, resources and a slot in which the set of aperiodic CSI-RS resources is transmitted.

In some embodiments, the method further comprises, after transmitting the signaling, receiving a control message that configures the wireless device with a triggering offset that has a value within the indicated range of values. In one or more of these embodiments, the control message includes a first parameter configurable to indicate a triggering offset within the indicated range of values. The control message may also be configurable with a second parameter for indicating a triggering offset within a different range of values, where the indicated range of values includes at least one value not included in the different range of values.

In some embodiments, the method further comprises receiving, in a first slot, downlink control information that triggers a set of aperiodic CSI-RS resources, and receiving, in a second slot, CSI-RS on the set of aperiodic CSI-RS resources triggered by the received downlink control information. In this case, the offset between the first slot and the second slot has a value within the indicated range of values. In one or more of these embodiments, the method further comprises, based on the triggering offset configured by the received control message, operating in a sleep state between the first slot and the second slot. In one or more of these embodiments. the downlink control information is received from a first cell and the CSI-RS is received from a second cell. In this case, the second cell has a higher subcarrier spacing, SCS, than the first cell.

In some embodiments, the indicated range of values for the triggering offset is extended as compared to a range of values supportable by another type of wireless device for the triggering offset.

In some embodiments, the indicated range of values for the triggering offset includes values above a value threshold and/or includes a number of values above a range size threshold.

Other embodiments herein include a method performed by a network node. The method comprises receiving signaling which indicates that a wireless device supports cross-slot scheduling. Support for cross-slot scheduling indicates a range of values that the wireless device supports for a triggering offset. Here, a triggering offset is an offset between a slot containing downlink control information that triggers a set of aperiodic channel state information reference signal, CSI-RS, resources, and a slot in which the set of aperiodic CSI-RS resources is transmitted.

In some embodiments, the method further comprises transmitting, to the wireless device, a control message which configures the wireless device with a triggering offset that has a value within the indicated range of values. In one or more of these embodiments, the control message includes a first parameter configurable to indicate a triggering offset within the indicated range of values. In this case, the control message is configurable with a second parameter for indicating a triggering offset within a different range of values, and the indicated range of values includes at least one value not included in the different range of values.

In some embodiments, the method further comprises transmitting aperiodic CSI-RS to the wireless device based on the received signaling.

In some embodiments, the method further comprises transmitting aperiodic CSI-RS to the wireless device on a set of aperiodic CSI-RS resources within a slot that is determined based on the received signaling.

In some embodiments, the method further comprises transmitting, in a first slot, to the wireless device, downlink control information that triggers a set of aperiodic CSI-RS resources. Additionally or alternatively, the method further comprises transmitting, in a second slot, to the wireless device, CSI-RS on the set of aperiodic CSI-RS resources triggered by the transmitted downlink control information. In this case, the offset between the first slot and the second slot has a value within the indicated range of values. In one or more of these embodiments, the downlink control information is transmitted from a first cell and the CSI-RS is transmitted from a second cell, and the second cell has a higher subcarrier spacing, SCS, than the first cell.

In some embodiments, the indicated range of values for the triggering offset is extended as compared to a range of values supportable by another type of wireless device for the triggering offset.

In some embodiments, the indicated range of values for the triggering offset includes values above a value threshold. Additionally or alternatively, the indicated range of values for the triggering offset includes a number of values above a range size threshold.

Other embodiments herein include a wireless device configured to transmit signaling which indicates that the wireless device supports cross-slot scheduling. In this case, support for cross-slot scheduling indicates a range of values that the wireless device supports for a triggering offset, a triggering offset being an offset between a slot containing downlink control information that triggers a set of aperiodic channel state information reference signal, CSI-RS, resources, and a slot in which the set of aperiodic CSI-RS resources is transmitted.

In some embodiments, the wireless device is configured to perform the steps described above for a wireless device.

Other embodiments herein include a network node configured to receive signaling which indicates that the wireless device supports cross-slot scheduling. Support for cross-slot scheduling indicates a range of values that the wireless device supports for a triggering offset. Here, a triggering offset is an offset between a slot containing downlink control information that triggers a set of aperiodic channel state information reference signal, CSI-RS, resources, and a slot in which the set of aperiodic CSI-RS resources is transmitted In some embodiments, the network node is configured to perform the steps described above for a network node.

Other embodiments herein include a computer program comprising instructions which, when executed by at least one processor of a wireless device, causes the wireless device to perform the steps described above for a wireless device. Other embodiments herein include a computer program comprising instructions which, when executed by at least one processor of a network node, causes the network node to perform the steps described above for a network node. In one or more of these embodiments, a carrier containing the computer program described above is one of an electronic signal, optical signal, radio signal, or computer readable storage medium.

Other embodiments herein include a wireless device comprising communication circuitry and processing circuitry. The processing circuitry is configured to transmit, via the communication circuitry, signaling which indicates that the wireless device supports cross-slot scheduling. Support for cross-slot scheduling indicates a range of values that the wireless device supports for a triggering offset. Here, a triggering offset is an offset between a slot containing downlink control information that triggers a set of aperiodic channel state information reference signal, CSI-RS, resources, and a slot in which the set of aperiodic CSI-RS resources is transmitted.

In some embodiments, the processing circuitry is configured to perform the steps described above for a wireless device.

Other embodiments herein include a network node comprising communication circuitry and processing circuitry. The processing circuitry is configured to receive, via the communication circuitry, signaling which indicates that the wireless device supports cross-slot scheduling. Support for cross-slot scheduling indicates a range of values that the wireless device supports for a triggering offset. Here, a triggering offset is an offset between a slot containing downlink control information that triggers a set of aperiodic channel state information reference signal, CSI-RS, resources, and a slot in which the set of aperiodic CSI-RS resources is transmitted. In some embodiments, the processing circuitry is configured to perform the steps described above for a network node.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a logic flow diagram of a method performed by a wireless device according to some embodiments.

FIG. 3 is a logic flow diagram of a method performed by a network node according to some embodiments.

FIG. 4 is a block diagram of a wireless device according to some embodiments.

FIG. 5 is a block diagram of a network node according to some embodiments.

FIG. 6 is a block diagram of a wireless communication network according to some embodiments.

FIG. 7 is a block diagram of a user equipment according to some embodiments.

FIG. 8 is a block diagram of a virtualization environment according to some embodiments.

FIG. 9 is a block diagram of a communication network with a host computer according to some embodiments.

FIG. 10 is a block diagram of a host computer according to some embodiments.

FIG. 11 is a flowchart illustrating a method implemented in a communication system, in accordance with one embodiment.

FIG. 12 is a flowchart illustrating a method implemented in a communication system, in accordance with one embodiment.

FIG. 13 is a flowchart illustrating a method implemented in a communication system, in accordance with one embodiment.

FIG. 14 is a flowchart illustrating a method implemented in a communication system, in accordance with one embodiment.

### DETAILED DESCRIPTION

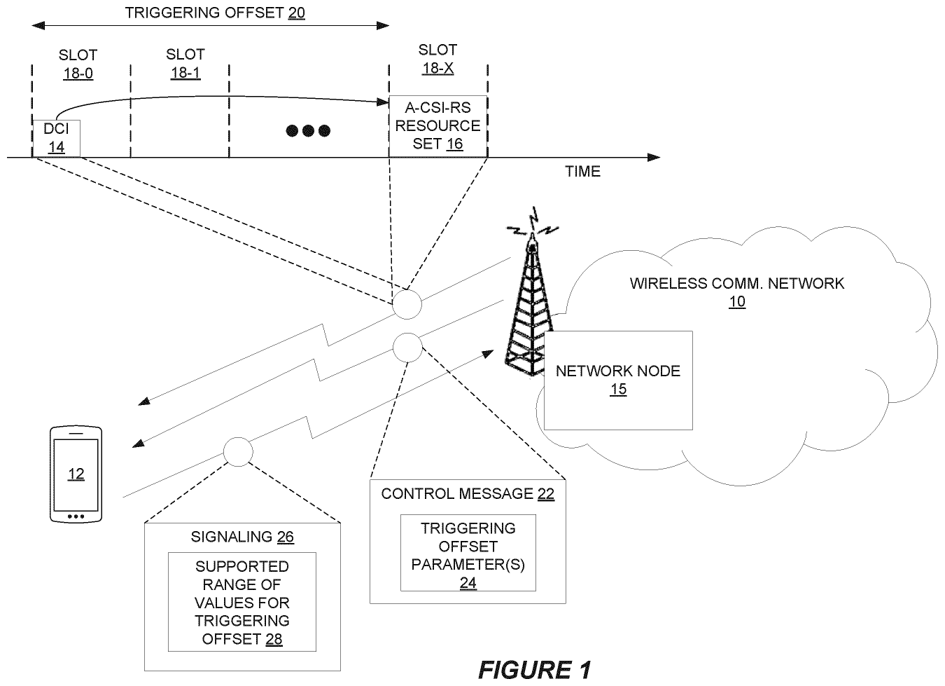

FIG. 1 shows a wireless communication network 10 configured to provide wireless communication service to a wireless device 12 according to some embodiments. Towards this end, the wireless device 12 is configured to receive downlink control information (DCI) 14 in a slot 18-0, e.g., via a Physical Downlink Control Channel, PDCCH. This DCI 14 triggers transmission of a set 16 of aperiodic channel state information (CSI) reference signal (RS) (CSI-RS) (A-CSI-RS) resources, e.g., a set of resources on which A-CSI-RS may be transmitted. In some embodiments, this set of A-CSI-RS resources is a set of non-zero-power (NZP) A-CSI-RS resources. The wireless device 12 in some embodiments receives the DCI 14 from the same network node, carrier, and/or cell as that from which the set 16 of A-CSI-RS resources is received, whereas in other embodiments the wireless device 12 receives the DCI 14 from a different network node, carrier, and/or cell as that from which the set 16 of A-CSI-RS resources is received. Regardless, the DCI 14 may trigger the set 16 of A-CSI-RS resources to be transmitted in a slot 18-X, such that there is an offset of X slots between the slot 18-0 in which the DCI 14 is received and the slot 18-X in which the set of A-CSI-RS resources is received. This offset of X slots is referred to and shown as a triggering offset 20.

In some embodiments, a network node 15 transmits to the wireless device 12 a control message 22 that configures the wireless device 12 with a value to be used for the triggering offset 20. The control message 22 may for example include one or more triggering offset parameters 24, each of which can be set to any of multiple possible values in order to signal which of those values is to be used for the triggering offset 20. Where the wireless communication network 10 conforms to 3GPP specifications, for instance, the triggering offset parameter(s) 24 may include an aperiodicTriggeringOffset parameter and/or an aperiodicTriggeringOffsetExt-r16 parameter. In this case, then, the aperiodicTriggeringOffset parameter can be set to any of the values 0 . . . 6, with the value 0 corresponding a triggering offset 20 of 0 slots, the value 1 corresponding a triggering offset 20 of 1 slot, the value 2 corresponding a triggering offset 20 of 2 slots, the value 3 corresponding a triggering offset 20 of 3 slots, the value 4 corresponding a triggering offset 20 of 4 slots, the value 5 corresponding a triggering offset 20 of 16 slots, and the value 6 corresponding a triggering offset 20 of 24 slots.

Alternatively or additionally, the aperiodicTriggeringOffsetExt-r16 parameter can be set to any of the values 0 . . . 31, with the value itself indicating that the triggering offset 20 is to have the same value, e.g., a value of 5 corresponds to a triggering offset 20 of 5 slots, a value of 30 corresponds to a triggering offset 20 of 30 slots, etc. In these and other embodiments, then, different triggering offset parameters 24 may have different ranges of possible values for the triggering offset 20.

According to some embodiments, the wireless device 12 transmits (e.g., to the network node 15) signaling 26 which indicates a range of values that the wireless device 12 supports for the triggering offset 20. By indicating the range of values that the wireless device 12 supports for the triggering offset 20, the network node 15 may more suitably configure the triggering offset 20 (e.g., via the control message 22). The network node 15 may for example advantageously configure the triggering offset 20 without any restrictions on configurability.

More particularly, in some embodiments, the signaling 26 indicates a range of values that the wireless device 12 supports for the triggering offset 20 by indicating that the wireless device supports a range of values for the triggering offset that is extended as compared to a range of values supportable by another type of wireless device for the triggering offset. The signaling 26 may for instance indicate that the wireless device 12 supports a certain triggering offset parameter in the control message 22, e.g., by indicating that the wireless device 12 supports the aperiodicTriggeringOffsetExt-r16 parameter, which is extended in range as compared to the aperiodicTriggeringOffset parameter. Alternatively or additionally, the signaling 26 may indicate a range of values that the wireless device 12 supports for the triggering offset 20 by indicating that the wireless device supports a range of values for the triggering offset according to a certain 3GPP Release, e.g., Release 16. Alternatively or additionally, the signaling 26 may indicate a range of values that the wireless device 12 supports for the triggering offset 20 by indicating that the wireless device 12 supports a range of values for the triggering offset 20 that includes values above a value threshold (e.g., above X=24) and/or that includes a number of values above a range size threshold (e.g., more than the 7 possible values of the aperiodicTriggeringOffset parameter). Alternatively or additionally, the signaling 26 may indicate a range of values that the wireless device 12 supports for the triggering offset 20 by indicating that the wireless device 12 supports a range of values for the triggering offset 20 that comprises values between 0 and 31. Alternatively or additionally, the signaling 26 may indicate a range of values that the wireless device 12 supports for the triggering offset 20 by indicating which values the wireless device 12 supports for the triggering offset 20.

Note that the signaling 26 may indicate any of the above explicitly or implicitly. The signaling 26 may indicate any of the above explicitly, for instance, if the signaling 26 includes one or more parameters whose value(s) directly represent or convey the above information, e.g., a parameter whose value directly indicates that the wireless device 12 supports the aperiodicTriggeringOffsetExt-r16 parameter or whose value directly indicates the range of values supported for the triggering offset 20. In these and other embodiments, the signaling 26 may indicate the range of values that the wireless device 12 supports for the triggering offset 20 independent of any support by the wireless device 12 for cross-slot scheduling and/or for cross-carrier aperiodic CSI-RS triggering with different subcarrier spacing.

By contrast, the signaling 26 may indicate any of the above implicitly, for instance, if the signaling 26 includes one or more parameters whose value(s) explicitly represent or convey something else, with the above information merely being implied or deduced therefrom. For example, in some embodiments, the signaling 26 explicitly indicates that the wireless device 12 supports cross-slot scheduling, and the wireless device's support for cross-slot scheduling implies that the wireless device 12 supports a certain range of values for the triggering offset 20, e.g., a range of 0 . . . 31 in accordance with the aperiodicTriggeringOffsetExt-r16 parameter. Alternatively or additionally, in other implicit signaling embodiments, the signaling 26 explicitly indicates that the wireless device 12 supports cross-carrier aperiodic CSI-RS triggering with different subcarrier spacing, and the wireless device's support for cross-carrier aperiodic CSI-RS triggering with different subcarrier spacing implies that the wireless device 12 supports a certain range of values for the triggering offset 20, e.g., a range of 0 . . . 31 in accordance with the aperiodicTriggeringOffsetExt-r16 parameter.

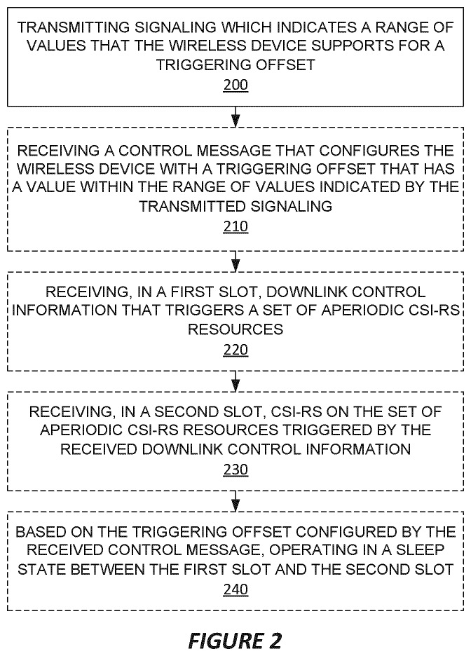

In view of the above modifications and variations, FIG. 2 depicts a method performed by a wireless device 12 in accordance with particular embodiments. The method includes transmitting signaling 26 which indicates a range of values that the wireless device 12 supports for a triggering offset 20 (Block 200). In some embodiments, a triggering offset 20 is an offset between: a slot 18-0 containing downlink control information 14 that triggers a set 16 of aperiodic channel state information reference signal (CSI-RS) resources; and a slot 18-X in which the set 16 of aperiodic CSI-RS resources is transmitted.

Note that, in some embodiments where the signaling 26 indicates the range of values implicitly, the signaling 26 may actually indicate that the wireless device 12 supports cross-slot scheduling, where such support for cross-slot scheduling indicates that the wireless device 12 supports a certain range of values for the triggering offset 20, e.g., a range of 0 . . . 31 in accordance with the aperiodicTriggeringOffsetExt-r16 parameter.

In some embodiments, the method also comprises, after transmitting the signaling 26, receiving a control message 22 that configures the wireless device 12 with a triggering offset 20 that has a value within the range of values indicated by the transmitted signaling 26 (Block 210).

In some embodiments, the method also comprises receiving, in a first slot 18-0, downlink control information 14 that triggers a set 16 of aperiodic CSI-RS resources (Block 220). The method may further comprise receiving, in a second slot 18-X, CSI-RS on the set 16 of aperiodic CSI-RS resources triggered by the received downlink control information 14 (Block 230). In one or more embodiments, the offset between the first slot 18-0 and the second slot 18-X has a value within the range of values indicated by the transmitted signaling 26.

In some embodiments, the method also comprises based on the triggering offset 20 configured by the received control message 22, operating in a sleep state between the first slot 18-0 and the second slot 18-X (Block 240).

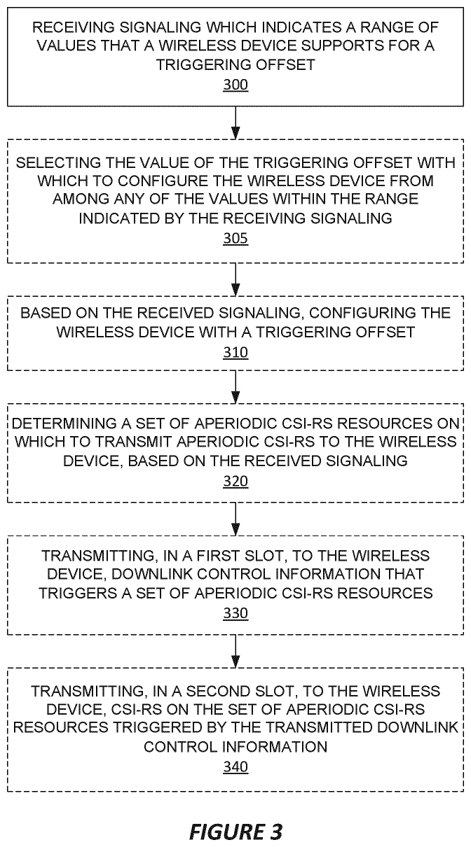

FIG. 3 depicts a method performed by a network node 15 (e.g., a radio network node) in accordance with other particular embodiments. The method includes receiving signaling 26 which indicates a range of values that a wireless device 12 supports for a triggering offset 20 (Block 300). In some embodiments, a triggering offset 20 is an offset between: a slot 18-0 containing downlink control information 14 that triggers a set 16 of aperiodic channel state information reference signal (CSI-RS) resources; and a slot 18-X in which the set 16 of aperiodic CSI-RS resources is transmitted.

Note that, in some embodiments where the signaling 26 indicates the range of values implicitly, the signaling 26 may actually indicate that the wireless device 12 supports cross-slot scheduling, where such support for cross-slot scheduling indicates that the wireless device 12 supports a certain range of values for the triggering offset 20, e.g., a range of 0 . . . 31 in accordance with the aperiodicTriggeringOffsetExt-r16 parameter.

In some embodiments, the method also comprises, based on the received signaling 26, configuring the wireless device 12 with a triggering offset 20 (Block 310). In one or more embodiments, this comprises transmitting, to the wireless device 12, a control message 22 which configures the wireless device 12 with a triggering offset 20 that has a value within the range of values indicated by the receiving signaling 26.

In some embodiments, the method also comprises selecting the value of the triggering offset 20 with which to configure the wireless device 12 from among any of the values within the range indicated by the receiving signaling 26 (Block 305).

In some embodiments, the method also comprises determining a set 16 of aperiodic CSI-RS resources on which to transmit aperiodic CSI-RS to the wireless device 12, based on the received signaling 26 (Block 320).

In some embodiments, the method also comprises transmitting, in a first slot 18-0, to the wireless device 12, downlink control information 14 that triggers a set 16 of aperiodic CSI-RS resources (Block 330).

In some embodiments, the method also comprises transmitting, in a second slot 18-X, to the wireless device 12, CSI-RS on the set 16 of aperiodic CSI-RS resources triggered by the transmitted downlink control information 14 (Block 340). In some embodiments, the offset between the first slot 18-0 and the second slot 18-X has a value within the range of values indicated by the received signaling 26.

Embodiments herein also include corresponding apparatuses. Embodiments herein for instance include a wireless device configured to perform any of the steps of any of the embodiments described above for the wireless device.

Embodiments also include a wireless device 12 comprising processing circuitry and power supply circuitry. The processing circuitry is configured to perform any of the steps of any of the embodiments described above for the wireless device 12. The power supply circuitry is configured to supply power to the wireless device 12. Embodiments further include a wireless device 12 comprising processing circuitry. The processing circuitry is configured to perform any of the steps of any of the embodiments described above for the wireless device 12. In some embodiments, the wireless device 12 further comprises communication circuitry.

Embodiments further include a wireless device 12 comprising processing circuitry and memory. The memory contains instructions executable by the processing circuitry whereby the wireless device 12 is configured to perform any of the steps of any of the embodiments described above for the wireless device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 15 configured to perform any of the steps of any of the embodiments described above for the network node 15.

Embodiments also include a network node 15 comprising processing circuitry and power supply circuitry. The processing circuitry is configured to perform any of the steps of any of the embodiments described above for the network node 15. The power supply circuitry is configured to supply power to the network node 15.

Embodiments further include a network node 15 comprising processing circuitry. The processing circuitry is configured to perform any of the steps of any of the embodiments described above for the network node 15. In some embodiments, the network node 15 further comprises communication circuitry.

Embodiments further include a network node 15 comprising processing circuitry and memory. The memory contains instructions executable by the processing circuitry whereby the network node 15 is configured to perform any of the steps of any of the embodiments described above for the network node 15.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

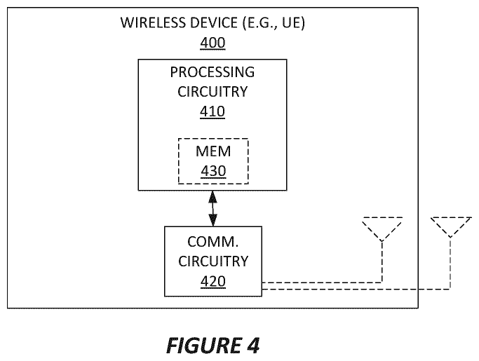

FIG. 4 for example illustrates a wireless device 400 (e.g., wireless device 12) as implemented in accordance with one or more embodiments. As shown, the wireless device 400 includes processing circuitry 410 and communication circuitry 420. The communication circuitry 420 (e.g., radio circuitry) is configured to transmit and/or receive information to and/or from one or more other nodes, e.g., via any communication technology. Such communication may occur via one or more antennas that are either internal or external to the wireless device 400. The processing circuitry 410 is configured to perform processing described above, e.g., in FIG. 2, such as by executing instructions stored in memory 430. The processing circuitry 410 in this regard may implement certain functional means, units, or modules.

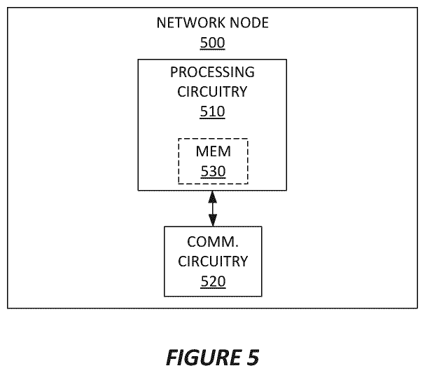

FIG. 5 illustrates a network node 500 (e.g., network node 15) as implemented in accordance with one or more embodiments. As shown, the network node 500 includes processing circuitry 510 and communication circuitry 520. The communication circuitry 520 is configured to transmit and/or receive information to and/or from one or more other nodes, e.g., via any communication technology. The processing circuitry 510 is configured to perform processing described above, e.g., in FIG. 3, such as by executing instructions stored in memory 530. The processing circuitry 510 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Note that, as used herein, a transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signaling is received, e.g. in relation to the timing grid. A transmission timing structure may in particular be a slot or subframe or in some cases, a mini-slot.

References to specific resource structures like transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4 symbols. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

In general, a numerology and/or subcarrier spacing may indicate the bandwidth (in frequency domain) of a subcarrier of a carrier, and/or the number of subcarriers in a carrier and/or the numbering of the subcarriers in a carrier. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Signaling may generally be considered to represent an electromagnetic wave structure (e.g., over a time interval and frequency interval), which is intended to convey information to at least one specific or generic (e.g., anyone who might pick up the signaling) target. A process of signaling may comprise transmitting the signaling. Transmitting signaling, in particular control signaling or communication signaling may comprise encoding and/or modulating. Encoding and/or modulating may comprise error detection coding and/or forward error correction encoding and/or scrambling. Receiving control signaling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to.

Example types of signaling comprise signaling of a specific communication direction, in particular, uplink signaling, downlink signaling, sidelink signaling, as well as reference signaling (e.g., SRS or CRS or CSI-RS), communication signaling, control signaling, and/or signaling associated to a specific channel like PUSCH, PDSCH, PUCCH, PDCCH, PSCCH, PSSCH, etc.).

Communication signaling may comprise, and/or represent, and/or be implemented as, data signaling, and/or user plane signaling. Communication signaling may be associated to a data channel, e.g. a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signaling may be signaling associated to and/or on a data channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information. It may in particular be considered that control signaling as described herein, based on the utilized resource sequence, implicitly indicates the control signaling type.

Additional embodiments will now be described. At least some of these embodiments may be described as applicable in certain contexts and/or wireless network types for illustrative purposes, but the embodiments are similarly applicable in other contexts and/or wireless network types not explicitly described.

In some embodiments, Channel State Information Reference Signals (CSI-RSs) are used for channel state feedback related to the use of transmission modes that enable UE-specific antenna precoding. These transmission modes use the UE-specific Demodulation Reference Symbols (DM-RSs) at the time of transmission with the precoding performed based on the feedback received from and measured by the UE on the CSI-RSs. The CSI-RS can be configured for a UE as Non-Zero-Power (NZP) and Zero-Power (ZP) instances. The NZP CSI-RS configuration indicates the resource elements (REs) where the cell being measured transmits CSI-RS and the ZP CSI-RS configuration indicates the REs where no information is transmitted by the cell being measured. The ZP CSI-RS REs are typically configured so that they overlap with transmissions from other cells which allows the UE to make interference measurements or Reference Signal Received Power (RSRP) measurements on the CSI-RS of other cells. Knowledge of the ZP CSI-RS configurations also allows the UE to not use these REs, i.e., rate-match around these REs when receiving the Physical Downlink Shared Channel (PDSCH).

In Rel-15, the A-CSI triggering offset value that can be configured is restricted to the set of values in {0, 1, 2, 3, 4, 16, 24} slots. For example, this RRC parameter can be aperiodicTriggeringOffset.

In Rel-16, a new RRC parameter is introduced for indicating a flexible A-CSI triggering offset value between 0 to 31 (in slots) i.e. with extended offset value range. For example, this RRC parameter can be aperiodicTriggeringOffsetExt-r16.

The Information Element (IE) NZP-CSI-RS-Resource is used to configure Non-Zero-Power (NZP) CSI-RS transmitted in the cell where the IE is included, which the UE may be configured to measure on.

NZP-CSI-RS-Resource information element

-- ASN1START
-- TAG-NZP-CSI-RS-RESOURCE-START

| NZP-CSI-RS-Resource ::= | SEQUENCE { | | |
|---|---|---|---|
| nzp-CSI-RS-ResourceId | NZP-CSI-RS-ResourceId, | | |
| resourceMapping | CSI-RS-ResourceMapping, | | |
| powerControlOffset | INTEGER (−8..15), | | |
| powerControlOffsetSS | ENUMERATED{db−3, db0, db3, db6} | OPTIONAL, | -- Need R |
| scramblingID | ScramblingId, | | |
| periodicityAndOffset | CSI-ResourcePeriodicityAndOffset | OPTIONAL, | -- Cond |
| PeriodicOrSemiPersistent | | | |

| | | |
|---|---|---|
| qcl-InfoPeriodicCSI-RS | TCI-StateId | OPTIONAL, -- Cond Periodic |

...
}
-- TAG-NZP-CSI-RS-RESOURCE-STOP
-- ASN1STOP

NZP-CSI-RS-Resource field descriptions
periodicityAndOffset
Periodicity and slot offset sl1 corresponds to a periodicity of 1 slot, sl2 to a periodicity of
two slots, and so on. The corresponding offset is also given in number of slots. Network
always configures the UE with a value for this field for periodic and semi-persistent NZP-
CSI-RS-Resource (as indicated in CSI-ResourceConfig).
powerControlOffset
Power offset of PDSCH RE to NZP CSI-RS RE. Value in dB
powerControlOffsetSS
Power offset of NZP CSI-RS RE to SSS RE. Value in dB
qcl-InfoPeriodicCSI-RS
For a target periodic CSI-RS, contains a reference to one TCI-State in TCI-States for
providing the QCL source and QCL type. For periodic CSI-RS, the source can be SSB or
another periodic-CSI-RS. Refers to the TCI-State which has this value for tci-StateId and is
defined in tci-StatesToAddModList in the PDSCH-Config included in the BWP-Downlink
corresponding to the serving cell and to the DL BWP to which the resource belongs to
resourceMapping
OFDM symbol location(s) in a slot and subcarrier occupancy in a PRB of the CSI-RS
resource.
scramblingID
Scrambling ID

| Conditional Presence | Explanation |
|---|---|
| Periodic | The field is optionally present, Need M, for periodic NZP- |
| | CSI-RS-Resources (as indicated in CSI-ResourceConfig). |
| | The field is absent otherwise. |
| PeriodicOrSemiPersistent | The field is optionally present, Need M, for periodic and |
| | semi-persistent NZP-CSI-RS-Resources (as indicated in |
| | CSI-ResourceConfig). The field is absent otherwise. |

The IE NZP-CSI-RS-Resourceld is used to identify one NZP-CSI-RS-Resource.

NZP-CSI-RS-ResourceId information element

-- ASN1START
-- TAG-NZP-CSI-RS-RESOURCEID-START

| | |
|---|---|
| NZP-CSI-RS-ResourceId ::= | INTEGER (0..maxNrofNZP-CSI-RS-Resources-1) |

-- TAG-NZP-CSI-RS-RESOURCEID-STOP
-- ASN1STOP

The IE NZP-CSI-RS-ResourceSet is a set of Non-Zero-Power (NZP) CSI-RS resources (their IDs) and set-specific parameters.

NZP-CSI-RS-ResourceSet information element

-- ASN1START
-- TAG-NZP-CSI-RS-RESOURCESET-START

| NZP-CSI-RS-ResourceSet ::= | SEQUENCE { | |
|---|---|---|
| nzp-CSI-ResourceSetId | NZP-CSI-RS-ResourceSetId, | |
| nzp-CSI-RS-Resources | SEQUENCE (SIZE (1 ..maxNrofNZP-CSI-RS- | |
| | ResourcesPerSet)) OF NZP-CSI-RS-ResourceId, | |
| repetition | ENUMERATED { on, off } | OPTIONAL, -- Need S |
| aperiodicTriggeringOffset | INTEGER(0..6) | OPTIONAL, -- Need S |

| | | |
|---|---|---|
| trs-Info | ENUMERATED {true} | OPTIONAL, -- Need R |

```
  ...,
  [[
```

| | | |
|---|---|---|
| aperiodicTriggeringOffsetExt-r16 | INTEGER(0..31) | OPTIONAL -- Need S |

]]
}
-- TAG-NZP-CSI-RS-RESOURCESET-STOP
-- ASN1STOP

NZP-CSI-RS-ResourceSet field descriptions

aperiodicTriggeringOffset, aperiodicTriggeringOffsetExt
Offset X between the slot containing the DCI that triggers a set of
aperiodic NZP CSI-RS resources and the slot in which the CSI-RS
resource set is transmitted. For aperiodicTriggeringOffset, the
value 0 corresponds to 0 slots, value 1 corresponds to 1 slot, value 2
corresponds to 2 slots, value 3 corresponds to 3 slots, value 4
corresponds to 4 slots, value 5 corresponds to 16 slots, value 6
corresponds to 24 slots. For aperiodicTriggeringOffsetExt, the value
indicates the number of slots. The network configures only one of
the fields. When neither field is included, the UE applies the value 0.
nzp-CSI-RS-Resources
NZP-CSI-RS-Resources associated with this NZP-CSI-RS resource
set. For CSI, there are at most 8 NZP CSI RS resources per resource set.
repetition
Indicates whether repetition is on/off. If the field is set to off or if the
field is absent, the UE may not assume that the NZP-CSI-RS resources
within the resource set are transmitted with the same downlink spatial
domain transmission filter. Can only be configured for CSI-RS
resource sets which are associated with CSI-ReportConfig with
report of L1 RSRP or “no report”.
trs-Info
Indicates that the antenna port for all NZP-CSI-RS resources in the
CSI-RS resource set is same. If the field is absent or released the UE
applies the value false.

The IE NZP-CSI-RS-ResourceSetld is used to identify one NZP-CSI-RS-ResourceSet.

NZP-CSI-RS-ResourceSetId information element

-- ASN1START
-- TAG-NZP-CSI-RS-RESOURCESETID-START

| | |
|---|---|
| NZP-CSI-RS-ResourceSetId ::= | INTEGER (0..maxNrofNZP-CSI-RS-ResourceSets-1) |

-- TAG-NZP-CSI-RS-RESOURCESETID-STOP
-- ASN1STOP

For a given NZP-CSI-RS resource set, a UE can be configured with a triggering offset value using one of the Rel-15 and Rel-16 parameters. An example TP update based on the above two parameters is as follows:

An example TP for RRC parameter name alignment is below (with bold underlined changes).

<Begin TP>

1.5.2.1.5.1 Aperiodic CSI Reporting/Aperiodic CSI-RS when the triggering PDCCH and the CSI-RS have the same numerology

### Omitted Text

When aperiodic CSI-RS is used with aperiodic reporting, the CSI-RS offset is configured per resource set by the higher layer parameter aperiodicTriggeringOffset or aperiodicTriggeringOffsetExt-r16. The CSI-RS triggering offset has the values of {0, 1, 2, 3, 4, 16, 24} slots. If the UE is not configured with [minimumSchedulingOffset] for any DL or UL bandwidth part (BWP) and if all the associated trigger states do not have the higher layer parameter qcl-Type set to ‘QCL-TypeD’ in the corresponding Transmission Configuration Indicator (TCI) states, the CSI-RS triggering offset is fixed to zero. The aperiodic triggering offset of the CSI Interference Measurement (CSI-IM) follows offset of the associated NZP CSI-RS for channel measurement.

### Omitted Text

2.5.2.1.5.1a Aperiodic CSI Reporting/Aperiodic CSI-RS when the triggering PDCCH and the CSI-RS have different numerologies

### Omitted Text

Aperiodic CSI-RS timing:

When the aperiodic CSI-RS is used with aperiodic CSI reporting, the CSI-RS triggering offset X is configured per resource set by the higher layer parameter aperiodicTriggeringOffset or aperiodicTriggeringOffsetExt-r16, including the case that the UE is not configured with [minimumSchedulingOffset] for any DL or UL BWP and all the associated trigger states do not have the higher layer parameter qcl-Type set to ‘QCL-TypeD’ in the corresponding TCI states. The CSI-RS triggering offset has the values of {0, 1, . . . , 31} slots when the PDCCH<μCSIRS and {0, 1, 2, 3, 4, 16, 24} when the μ_{PDCCH}>μ_{CIRS}. The aperiodic CSI-RS is transmitted in a slot

$$⌊ n \cdot \frac{{2}^{{μ}_{CSIRS}}}{{2}^{{μ}_{PDCCH}}} ⌋ + X + ⌊ ( \frac{{N}_{slot , offset , PDCCH}^{CA}}{{2}^{{μ}_{offset , PDCCH}}} - \frac{{N}_{s lot , offset , CSIRS}^{C A}}{{2}^{{μ}_{offset , CSIRS}}} ) \cdot {2}^{{μ}_{CSIRS}} ⌋ ,$$

if UE is configured with ca-SlotOffset for at least one of the triggered and triggering cell, and

$${K}_{s} = ⌊ n \cdot \frac{{2}^{{μ}_{CSIRS}}}{{2}^{{μ}_{PDCCH}}} ⌋ + X ,$$

otherwise, and where

n is the slot containing the triggering DCI, Xis the CSI-RS triggering offset in the numerology of CSI-RS according to the higher layer parameter aperiodicTriggeringOffset or aperiodicTriggeringOffsetExt-r16,

μ_{CSIRS} and μ_{PDCCH} are the subcarrier spacing configurations for CSI-RS and PDCCH, respectively,

### Omitted Text

<End TP>

The use case for the extended offset value range may enable more efficient/flexible A-CSI triggering offset configuration for the case when a Physical Downlink Control Channel (PDCCH) on a first cell with a lower subcarrier spacing (SCS) schedules an A-CSI-RS transmission on a second cell with higher SCS.

Another use case for the extended offset value range is to enable more efficient/flexible A-CSI triggering offset configuration for the case when a UE supports cross-slot scheduling based power savings, wherein a minimum scheduling offset restriction is applied for PDSCH scheduling, and the same restriction is also applied for A-CSI-RS triggering offset. For example, if a minimum scheduling offset restriction is applicable (e.g. min K0=5), then UE will not expect to be scheduled using a DCI that indicates a Physical Downlink Shared Channel (PDSCH) scheduling offset of K0<5 and the UE will not expect to be scheduled using a DCI that indicates a A-CSI triggering offset smaller than 5. This can be applied for all cases including same-SCS scheduling (including same-carrier scheduling), high-SCS-PDCCH scheduling lower-SCS PDSCH/A-CSI-RS, and lower-SCS PDCCH scheduling higher-SCS PDSCH/A-CSI-RS.

The case where a UE indicates capability for support for configuration of the extended offset value range for A-CSI triggering offset will now be described, e.g., so as to illustrate various examples of signaling 26 in FIG. 1.

In an embodiment, a UE indicating support for “Cross Slot Scheduling” also indicates the capability (e.g. implicitly or explicitly) to support the new RRC parameter (e.g. aperiodicTriggeringOffsetExt-r16.) and/or the extended offset value range for A-CSI triggering offset. For example, in the implicit case, support of extended offset value range for A-CSI triggering offset via aperiodicTriggeringOffsetExt-r16 can become a component within the capability to “Cross Slot Scheduling”.

In an embodiment, a UE indicates a separate capability to support the new RRC parameter (e.g. aperiodicTriggeringOffsetExt-r16.) and/or the extended offset value range for A-CSI triggering offset. For example, the capability can be separate from the capability indicating support for “Cross-carrier A-CSI RS triggering with different SCS” and/or “Cross slot scheduling”. For example, a new feature group may be introduced for this option.

In an embodiment, a UE indicating capability to “Cross-carrier A-CSI RS triggering with different SCS” also indicates the capability (e.g. implicitly or explicitly) to support the new RRC parameter (e.g. aperiodicTriggeringOffsetExt-r16.) and/or the extended offset value range for A-CSI triggering offset. For example, in the implicit case, support of extended offset value range for A-CSI triggering offset via aperiodicTriggeringOffsetExt-r16 can become a component within the capability to “Cross-carrier A-CSI RS triggering with different SCS”.

Cross-slot scheduling capability (e.g. 19-2) may have a component as follows:
Dynamic indication of applicable minimum scheduling restriction by DCI format 0_1 and 1_1
minimumSchedulingOffset K0 configuration for PDSCH and aperiodic CSI-RS triggering offset

minimumSchedulingOffset K2 configuration for PUSCH

Cross-carrier A-CSI RS triggering with different SCS capability (e.g. 18-6) may have a component as follows: Cross-carrier A-CSI RS triggering with different SCS.

As described in some of previous embodiments, an additional component as follows can be added to one or both of the above capabilities: support of extended offset value range for A-CSI triggering offset via aperiodicTriggeringOffsetExt-r16.

As described in one of previous embodiments, an additional new capability can be introduced “support of extended offset value range for A-CSI triggering offset” with the following component: support of extended offset value range for A-CSI triggering offset via aperiodicTriggeringOffsetExt-r16.

Note: the new capability can be independent of other capabilities e.g. 19-2 or 18-6.

A gNB upon receiving the UE capability signaling according to one of the above embodiments (e.g., as examples of signaling 26), can suitably configure the A-CSI triggering offset for the UE.

Since a UE indicates capability support of extended offset value range for A-CSI triggering offset, in one embodiment, the extended value range can be used regardless of whether the corresponding feature (Cross-carrier A-CSI-RS triggering with different SCS or Cross-slot scheduling) is enabled or not. The cases where it is configurable may be clear from 3GPP specifications already in some cases such as “The CSI-RS triggering offset has the values of {0, 1, . . . , 31} slots when the μ_{PDCCH}<μ_{CSIRS}”, where μ denotes the numerology corresponding to the SCS for control channel (PDCCH) and SCS for CSI-RS. μ=0,1,2,3, for 15 kHz, 30 kHz, 60 kHz, and 120 kHz, respectively.

However, in some cases such as UEs supporting cross-slot scheduling, it may not be so clear from the 3GPP specification. For the Cross-slot scheduling case, there may be some additional conditions added under which a UE may support the extended offset value range for A-CSI triggering offset via aperiodicTriggeringOffsetExt-r16.
The CSI-RS triggering offset has the extended value range (e.g. of {0, 1, 2, 3, 4, 5, 6 . . . 15, 16, 24} slots) for any DL bandwidth part (BWP) when the UE is configured with minimum scheduling offset value (e.g. for DL or UL) for at least one BWP.
The CSI-RS triggering offset has the extended value range (e.g. of {0, 1, 2, 3, 4, 5, 6 . . . 15, 16, 24} slots) for a DL BWP when the UE is configured with minimum scheduling offset (e.g. for DL) for the DL BWP.

The CSI-RS triggering offset with extended value range (e.g. of {0, 1, 2, 3, 4, 5, 6 . . . 15, 16, 24} slots) can be configured only for a DL BWP when the UE is configured with minimum scheduling offset (e.g. for DL) for the DL BWP.
The CSI-RS triggering offset with extended value range (e.g. of {0, 1, 2, 3, 4, 5, 6 . . . 15, 16, 24} slots) can be configured for any DL BWP only when the UE is configured with minimum scheduling offset (e.g. for DL or UL) for at least one BWP.

In some cases, if a UE indicates support of the new RRC parameter (e.g. aperiodicTriggeringOffsetExt-r16.) and/or the extended offset value range for A-CSI triggering offset, the CSI-RS triggering offset with extended value range can be applied without any restrictions on configurability.

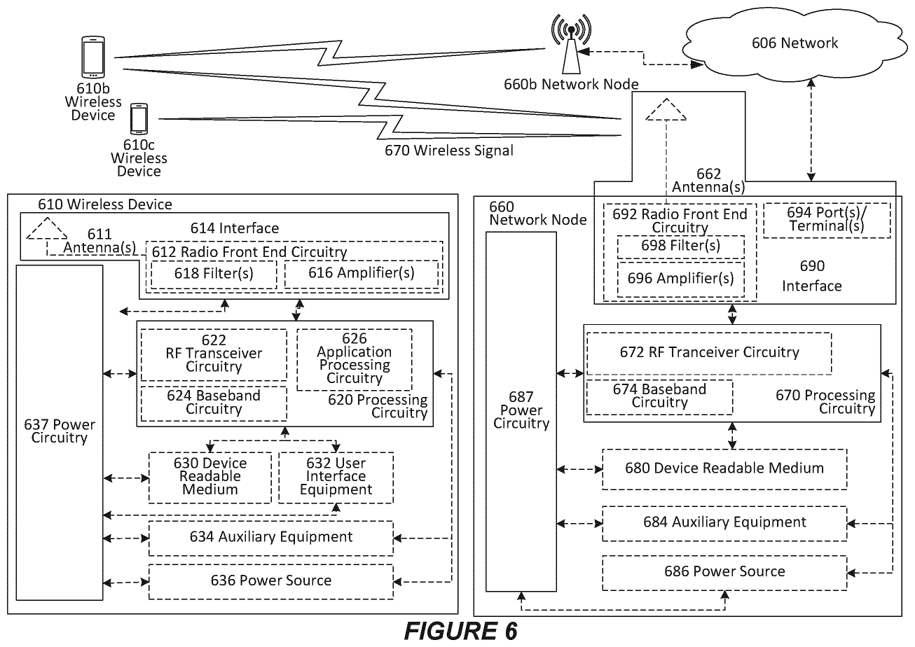

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662.

Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

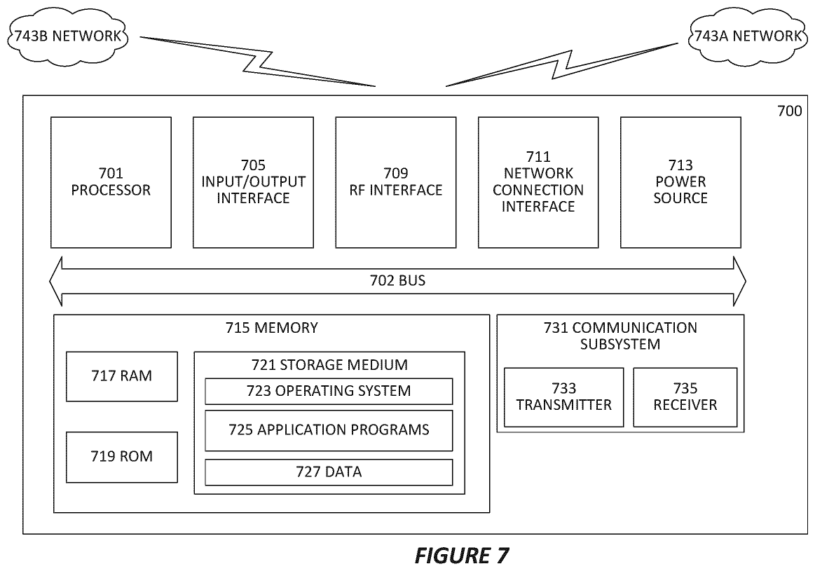

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 7200 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP′s GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.7, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

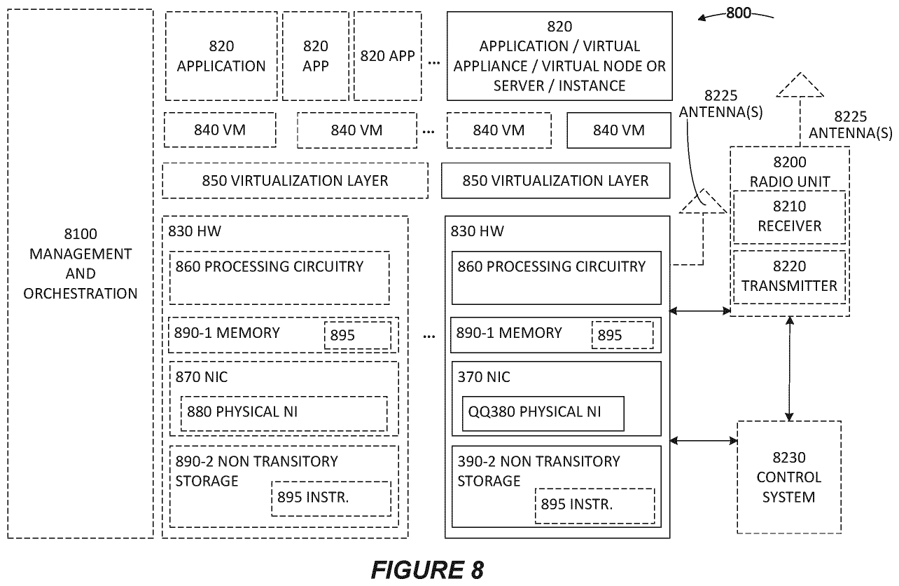

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

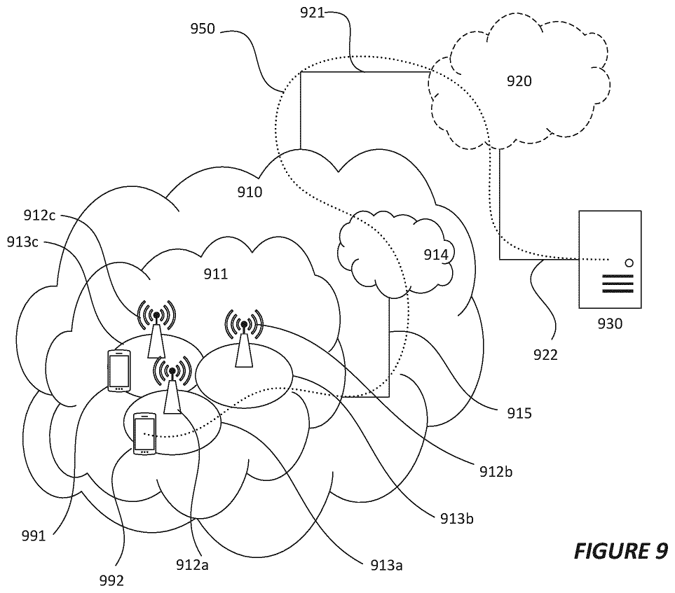

FIG. 9 illustrates a telecommunication network connected via an intermediate network to a host computer in accordance with some embodiments. In particular, with reference to

FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c.

Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

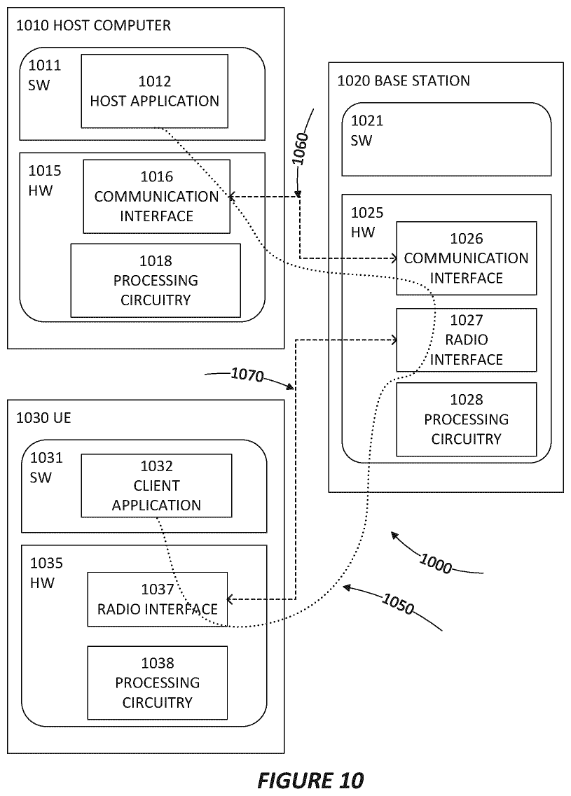

Example implementations, in accordance with an embodiment, of the UE, base station and host computer discussed in the preceding paragraphs will now be described with reference to FIG. 10. FIG. 10 illustrates host computer communicating via a base station with a user equipment over a partially wireless connection in accordance with some embodiments In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010′s measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

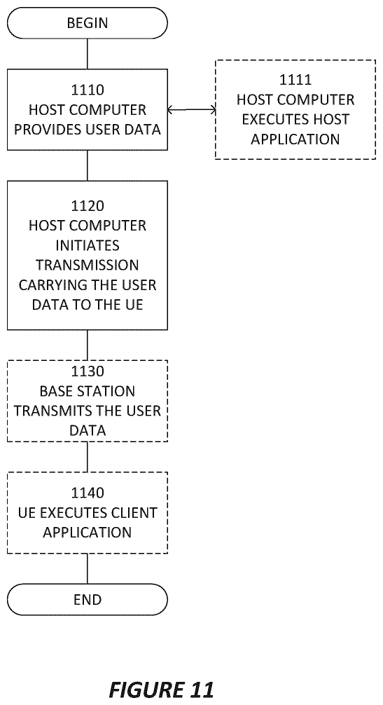

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application.

In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

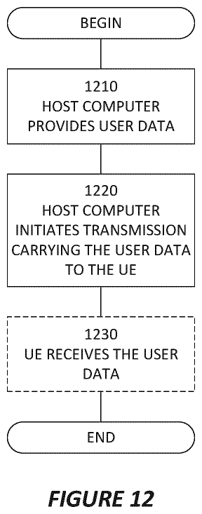

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

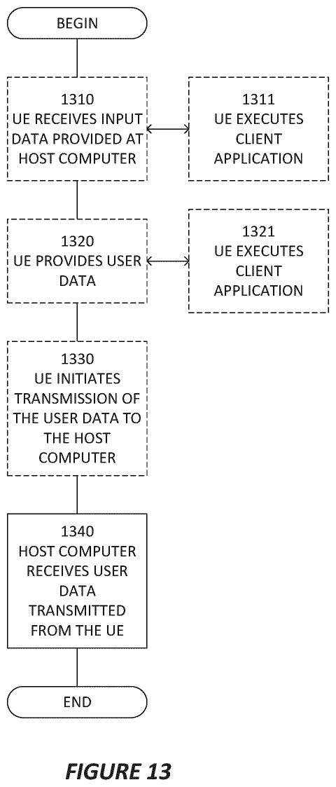

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

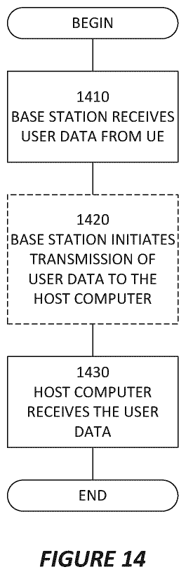

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data. In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless device, the method comprising: transmitting signaling which indicates a range of values that the wireless device supports for a triggering offset, wherein a triggering offset is an offset between:
   a slot containing downlink control information that triggers a set of aperiodic channel state information reference signal, CSI-RS, resources; and
   a slot in which the set of aperiodic CSI-RS resources is transmitted.
A2. The method of embodiment A1, further comprising, after transmitting the signaling, receiving a control message that configures the wireless device with a triggering offset that has a value within the range of values indicated by the transmitted signaling.
A3. The method of embodiment A2, further comprising:
   receiving, in a first slot, downlink control information that triggers a set of aperiodic CSI-RS resources; and
   receiving, in a second slot, CSI-RS on the set of aperiodic CSI-RS resources triggered by the received downlink control information, wherein the offset between the first slot and the second slot has a value within the range of values indicated by the transmitted signaling.
A4. The method of embodiment A3, further comprising, based on the triggering offset configured by the received control message, operating in a sleep state between the first slot and the second slot.
A5. The method of embodiment A3, wherein the downlink control information is received from a first cell and the CSI-RS is received from a second cell, wherein the second cell has a higher subcarrier spacing, SCS, than the first cell.
A6. The method of any of embodiments A1-A5, wherein the signaling indicates that the wireless device supports a range of values for the triggering offset that is extended as compared to a range of values supportable by another type of wireless device for the triggering offset.
A7. The method of any of embodiments A1-A6, wherein the signaling indicates that the wireless device supports a range of values for the triggering offset that includes values above a value threshold and/or that includes a number of values above a range size threshold.
A8. The method of any of embodiments A1-A7, wherein the signaling indicates that the wireless device supports a range of values for the triggering offset that comprises values between 0 and 31.
A9. The method of any of embodiments A1-A8, wherein the signaling indicates that the wireless device supports a range of values for the triggering offset according to a certain 3GPP Release.
A10. The method of any of embodiments A1-A9, wherein the signaling indicates the range of values that the wireless device supports for a triggering offset by indicating that the wireless device supports a certain parameter in a control message that configures the triggering offset.
A11. The method of embodiment A10, wherein the certain parameter is an aperiodicTriggeringOffsetExt-r16 parameter, and wherein the control message is a Radio Resource Control, RRC, message.

A12. The method of any of embodiments A1-A9, wherein the signaling indicates the range of values that the wireless device supports for a triggering offset by indicating which values the wireless device supports for the triggering offset.

A13. The method of any of embodiments A1-A9, wherein the signaling indicates the range of values that the wireless device supports for a triggering offset by indicating that the wireless device supports cross-slot scheduling.

A14. The method of any of embodiments A1-A9, wherein the signaling indicates the range of values that the wireless device supports for a triggering offset by indicating that the wireless device supports cross-carrier aperiodic CSI-RS triggering with different subcarrier spacing.

A15. The method of any of embodiments A1-A9, wherein the signaling indicates the range of values that the wireless device supports for a triggering offset independent of any support by the wireless device for cross-slot scheduling and/or for cross-carrier aperiodic CSI-RS triggering with different subcarrier spacing.
AA. The method of any of the previous embodiments, further comprising:
   providing user data; and
   forwarding the user data to a host computer via the transmission to a base station.

### Group B Embodiments

B1. A method performed by a network node, the method comprising:
   receiving signaling which indicates a range of values that a wireless device supports for
      a triggering offset, wherein the triggering offset is an offset between:
      a slot containing downlink control information that triggers a set of aperiodic channel state information reference signal, CSI-RS, resources; and
      a slot in which the set of aperiodic CSI-RS resources is transmitted.
B2. The method of embodiment B1, further comprising, based on the received signaling, configuring the wireless device with a triggering offset.
B3. The method of any of embodiments B1-B2, further comprising transmitting, to the wireless device, a control message which configures the wireless device with a triggering offset that has a value within the range of values indicated by the receiving signaling.
B4. The method of any of embodiments B1-B3, further comprising selecting the value of the triggering offset with which to configure the wireless device from among any of the values within the range indicated by the receiving signaling.

B5. The method of any of embodiments B1-B4, further comprising transmitting aperiodic CSI-RS to the wireless device based on the received signaling.
B6. The method of any of embodiments B1-B5, further comprising determining a set of aperiodic CSI-RS resources on which to transmit aperiodic CSI-RS to the wireless device, based on the received signaling.
B7. The method of any of embodiments B1-B6, further comprising determining a slot in which a set of aperiodic CSI-RS resources is to be transmitted to the wireless device, based on the received signaling.
B8. The method of any of embodiments B1-B7, further comprising transmitting aperiodic CSI-RS to the wireless device on a set of aperiodic CSI-RS resources within a slot that is determined based on the received signaling.
B9. The method of any of embodiments B1-B8, further comprising:
   transmitting, in a first slot, to the wireless device, downlink control information that triggers a set of aperiodic CSI-RS resources; and/or
   transmitting, in a second slot, to the wireless device, CSI-RS on the set of aperiodic CSI-RS resources triggered by the transmitted downlink control information, wherein the offset between the first slot and the second slot has a value within the range of values indicated by the received signaling.
B10. The method of embodiment B9, wherein the downlink control information is transmitted from a first cell and the CSI-RS is transmitted from a second cell, wherein the second cell has a higher subcarrier spacing, SCS, than the first cell.
B11. The method of any of embodiments B1-B5, wherein the signaling indicates that the wireless device supports a range of values for the triggering offset that is extended as compared to a range of values supportable by another type of wireless device for the triggering offset.
B12. The method of any of embodiments B1-B11, wherein the signaling indicates that the wireless device supports a range of values for the triggering offset that includes values above a value threshold and/or that includes a number of values above a range size threshold.
B13. The method of any of embodiments B1-B12, wherein the signaling indicates that the wireless device supports a range of values for the triggering offset that comprises values between 0 and 31.
B14. The method of any of embodiments B1-B13, wherein the signaling indicates that the wireless device supports a range of values for the triggering offset according to a certain 3GPP Release.
B15. The method of any of embodiments B1-B14, wherein the signaling indicates the range of values that the wireless device supports for a triggering offset by indicating that the wireless device supports a certain parameter in a control message that configures the triggering offset.
B16. The method of embodiment B15, wherein the certain parameter is an aperiodicTriggeringOffsetExt-r16 parameter, and wherein the control message is a Radio Resource Control, RRC, message.
B17. The method of any of embodiments B1-B14, wherein the signaling indicates the range of values that the wireless device supports for a triggering offset by indicating which values the wireless device supports for the triggering offset.
B18. The method of any of embodiments B1-B14, wherein the signaling indicates the range of values that the wireless device supports for a triggering offset by indicating that the wireless device supports cross-slot scheduling.
B19. The method of any of embodiments B1-B14, wherein the signaling indicates the range of values that the wireless device supports for a triggering offset by indicating that the wireless device supports cross-carrier aperiodic CSI-RS triggering with different subcarrier spacing.
B20. The method of any of embodiments B1-B14, wherein the signaling indicates the range of values that the wireless device supports for a triggering offset independent of any support by the wireless device for cross-slot scheduling and/or for cross-carrier aperiodic CSI-RS triggering with different subcarrier spacing.
B21. The method of any of embodiments B1-B20, wherein the network node is a radio network node.
BB. The method of any of the previous embodiments, further comprising:
   obtaining user data; and
   forwarding the user data to a host computer or a wireless device.

### Group C Embodiments

C1. A wireless device configured to perform any of the steps of any of the Group A embodiments.
C2. A wireless device comprising processing circuitry configured to perform any of the steps of any of the Group A embodiments.
C3. A wireless device comprising:
   communication circuitry; and
   processing circuitry configured to perform any of the steps of any of the Group A embodiments.
C4. A wireless device comprising:
   processing circuitry configured to perform any of the steps of any of the Group A embodiments; and
   power supply circuitry configured to supply power to the wireless device.
C5. A wireless device comprising:
   processing circuitry and memory, the memory containing instructions executable by the processing circuitry whereby the wireless device is configured to perform any of the steps of any of the Group A embodiments.
C6. A user equipment (UE) comprising:
   an antenna configured to send and receive wireless signals;
   radio front-end circuitry connected to the antenna and to processing circuitry, and
      configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C7. A computer program comprising instructions which, when executed by at least one processor of a wireless device, causes the wireless device to carry out the steps of any of the Group A embodiments.
C8. A carrier containing the computer program of embodiment C7, wherein the carrier is one of an electronic signal, optical signal, radio signal, or computer readable storage medium.
C9. A network node configured to perform any of the steps of any of the Group B embodiments.
C10. A network node comprising processing circuitry configured to perform any of the steps of any of the Group B embodiments.
C11. A network node comprising:
   communication circuitry; and
   processing circuitry configured to perform any of the steps of any of the Group B embodiments.
C12. A network node comprising:
   processing circuitry configured to perform any of the steps of any of the Group B embodiments;
   power supply circuitry configured to supply power to the network node.
C13. A network node comprising:
   processing circuitry and memory, the memory containing instructions executable by the processing circuitry whereby the network node is configured to perform any of the steps of any of the Group B embodiments.
C14. The network node of any of embodiments C9-C13, wherein the network node is a base station.
C15. A computer program comprising instructions which, when executed by at least one processor of a network node, causes the network node to carry out the steps of any of the Group B embodiments.
C16. The computer program of embodiment C14, wherein the network node is a base station.
C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the previous embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps of any of the Group A embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
D28. The method of the previous embodiment, further comprising at the base station, receiving the user data from the UE.
D29. The method of the previous 2 embodiments, further comprising at the base station, initiating a transmission of the received user data to the host computer.

1.-28. (canceled)

29. A method performed by a wireless device, the method comprising:
transmitting signaling which indicates that the wireless device supports cross-slot scheduling, wherein support for cross-slot scheduling indicates a range of values that the wireless device supports for a triggering offset, wherein a triggering offset is an offset between:
a slot containing downlink control information that triggers a set of aperiodic channel state information reference signal (CSI-RS) resources; and
a slot in which the set of aperiodic CSI-RS resources is transmitted.

30. The method of claim 29, further comprising, after transmitting the signaling, receiving a control message that configures the wireless device with a triggering offset that has a value within the indicated range of values.

31. The method of claim 30, wherein the control message includes a first parameter configurable to indicate a triggering offset within the indicated range of values, wherein the control message is configurable with a second parameter for indicating a triggering offset within a different range of values, wherein the indicated range of values includes at least one value not included in the different range of values.

32. The method of claim 29, further comprising:
receiving, in a first slot, downlink control information that triggers a set of aperiodic CSI-RS resources; and
receiving, in a second slot, CSI-RS on the set of aperiodic CSI-RS resources triggered by the received downlink control information, wherein the offset between the first slot and the second slot has a value within the indicated range of values.

33. The method of claim 32, further comprising, based on the triggering offset configured by the received control message, operating in a sleep state between the first slot and the second slot.

34. The method of claim 32, wherein the downlink control information is received from a first cell and the CSI-RS is received from a second cell, wherein the second cell has a higher subcarrier spacing (SCS) than the first cell.

35. The method of claim 29, wherein the indicated range of values for the triggering offset is extended as compared to a range of values supportable by another type of wireless device for the triggering offset.

36. The method of claim 29, wherein the indicated range of values for the triggering offset includes values above a value threshold and/or includes a number of values above a range size threshold.

37. A method performed by a network node, the method comprising:
receiving signaling which indicates that a wireless device supports cross-slot scheduling, wherein support for cross-slot scheduling indicates a range of values that the wireless device supports for a triggering offset, wherein a triggering offset is an offset between:
a slot containing downlink control information that triggers a set of aperiodic channel state information reference signal (CSI-RS) resources; and
a slot in which the set of aperiodic CSI-RS resources is transmitted.

38. The method of claim 37, further comprising transmitting, to the wireless device, a control message which configures the wireless device with a triggering offset that has a value within the indicated range of values.

39. The method of claim 38, wherein the control message includes a first parameter configurable to indicate a triggering offset within the indicated range of values, wherein the control message is configurable with a second parameter for indicating a triggering offset within a different range of values, wherein the indicated range of values includes at least one value not included in the different range of values.

40. The method of claim 37, further comprising transmitting aperiodic CSI-RS to the wireless device based on the received signaling.

41. The method of claim 37, further comprising transmitting aperiodic CSI-RS to the wireless device on a set of aperiodic CSI-RS resources within a slot that is determined based on the received signaling.

42. The method of claim 37, further comprising:
transmitting, in a first slot, to the wireless device, downlink control information that triggers a set of aperiodic CSI-RS resources; and/or
transmitting, in a second slot, to the wireless device, CSI-RS on the set of aperiodic CSI-RS resources triggered by the transmitted downlink control information, wherein the offset between the first slot and the second slot has a value within the indicated range of values.

43. The method of claim 42, wherein the downlink control information is transmitted from a first cell and the CSI-RS is transmitted from a second cell, wherein the second cell has a higher subcarrier spacing (SCS) than the first cell.

44. The method of claim 37, wherein the indicated range of values for the triggering offset is extended as compared to a range of values supportable by another type of wireless device for the triggering offset.

45. The method of claim 37, wherein the indicated range of values for the triggering offset includes values above a value threshold and/or that includes a number of values above a range size threshold.

46. A wireless device comprising:
communication circuitry; and
processing circuitry configured to transmit, via the communication circuitry, signaling which indicates that the wireless device supports cross-slot scheduling, wherein support for cross-slot scheduling indicates a range of values that the wireless device supports for a triggering offset, wherein a triggering offset is an offset between:
a slot containing downlink control information that triggers a set of aperiodic channel state information reference signal (CSI-RS) resources; and
a slot in which the set of aperiodic CSI-RS resources is transmitted.

47. The wireless device of claim 46, the processing circuitry further configured to, after transmitting the signaling, receive a control message that configures the wireless device with a triggering offset that has a value within the indicated range of values.

48. The wireless device of claim 47, wherein the control message includes a first parameter configurable to indicate a triggering offset within the indicated range of values, wherein the control message is configurable with a second parameter for indicating a triggering offset within a different range of values, wherein the indicated range of values includes at least one value not included in the different range of values.

49. The wireless device of claim 46, the processing circuitry further configured to:
receive, in a first slot, downlink control information that triggers a set of aperiodic CSI-RS resources; and
receive, in a second slot, CSI-RS on the set of aperiodic CSI-RS resources triggered by the received downlink control information, wherein the offset between the first slot and the second slot has a value within the indicated range of values.

50. The wireless device of claim 49, the processing circuitry further configured to, based on the triggering offset configured by the received control message, operate in a sleep state between the first slot and the second slot.

51. The wireless device of claim 49, wherein the downlink control information is received from a first cell and the CSI-RS is received from a second cell, wherein the second cell has a higher subcarrier spacing (SCS) than the first cell.

52. The wireless device of claim 46, wherein the indicated range of values for the triggering offset is extended as compared to a range of values supportable by another type of wireless device for the triggering offset.

53. The wireless device of claim 46, wherein the indicated range of values for the triggering offset includes values above a value threshold and/or includes a number of values above a range size threshold.
